(19) United States
(12) Patent Application Publication
(10) Pub. No.: US 2007/0120494 A1
(43) Pub. Date: May 31, 2007

(54) Vehicle daytime running light control system

(76) Inventors: Jeremy A. Lahr, Columbia City, IN (US); Allyson K. Kreft, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/288,515

(22) Filed: Nov. 29, 2005

(51) Int. Cl. B60Q 1/02

(52) U.S. Cl. 315/82

(57) ABSTRACT

A vehicle lighting control system provides tailored implementation of daytime running light operation. Daytime running light operation is triggered in response to selected vehicle conditions, typically including, ignition key position, release of the park brake and selection of the off state for the vehicle headlamps. The occurrence of additional conditions results in cancellation or suspension of operation. Suspension follows from setting of the parking brake, typically without activation of school bus warning lights.

### BACKGROUND OF THE INVENTION

1. Technical Field

The invention relates to vehicle lighting control and more particularly to a system allowing selective, and automatic, operation of a vehicle's exterior lamps in daytime running mode.

2. Description of the Problem

Selected exterior vehicle lights, particularly headlamps, can be operated in the daytime to increase the visibility of the vehicle to others. Such operation is referred to as daytime running light (DRL) operation. DRL operation of vehicle lamps may involve illumination of the headlamps at reduced power to reduce the load on the vehicle electrical system and extend the life of the headlamp bulbs as compared with full power operation. However, whether the lights are operated at reduced power settings or not, DRL operation of the lamps represents a non-negligible electrical load which increases fuel usage and reduces lamp service life. It would be desirable to limit DRL operation to periods when actually required.

A simplistic approach to the issue might conclude that DRL operation can be limited to when the vehicle is in motion. However, state and provincial law may control DRL operation for school busses, particularly when embarking and disembarking pupils. Such requirements may differ depending upon key ignition status, parking brake status and whether pupil warning lights are activated or not. For example, it is clear that a vehicle should not be in motion when the parking brake is set, however, state requirements may stipulate that the daytime running light operation is required at any time that the pupil warning lights are operating and may require parking brakes be set when children are present.

### SUMMARY OF THE INVENTION

The invention provides a lighting control system implementing daytime running light operation, tailored to meet jurisdictional requirements. Daytime running light operation is triggered in response to selected vehicle conditions, typically including at a minimum, ignition key position, release of the park brake, engine operational status and status of pupil warning lights. In a school bus the headlamps are operated in a daytime running light mode unless such operation is canceled or suspended. Cancellation occurs in response to selected conditions being met or no longer holding true.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a school bus with which the system for control of daytime running lights is advantageously used.

FIG. 2 is a mixed circuit schematic and block diagram of a electrical control system for a vehicle including lighting control.

FIG. 3 is a truth table implemented through programming of an electrical system controller or body computer for the vehicle of FIG. 1.

### DETAILED DESCRIPTION OF THE INVENTION

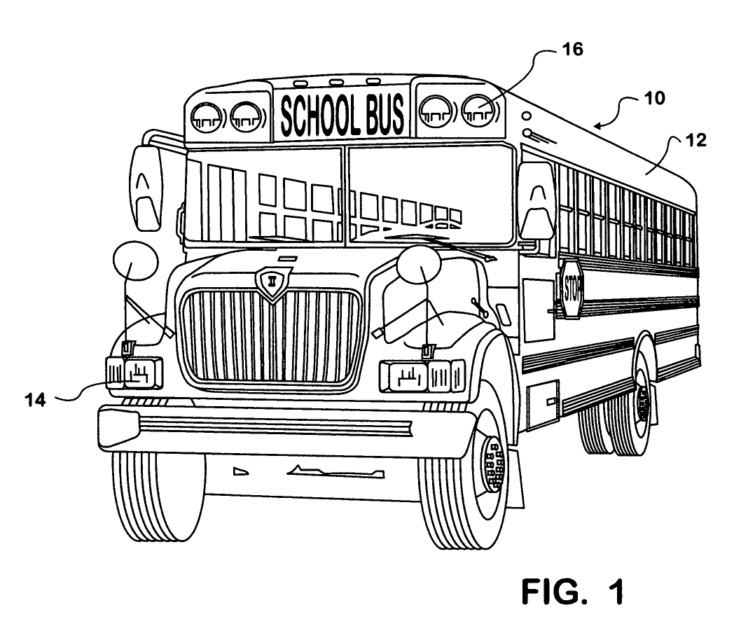

Referring now to the figures and in particular to FIG. 1, a vehicle 10 is illustrated. Vehicle 10 includes a school bus body 12 installed on a chassis. School bus body 12 is equipped with conventional exterior lamps including at least pupil boarding warning lights 16 and headlamps 14. Conventionally, daytime running light operation of vehicle exterior lamps includes illuminating the vehicle headlamps 14, sometimes at a reduced level, to limit the load on the vehicle electrical system and extend lamp service life.

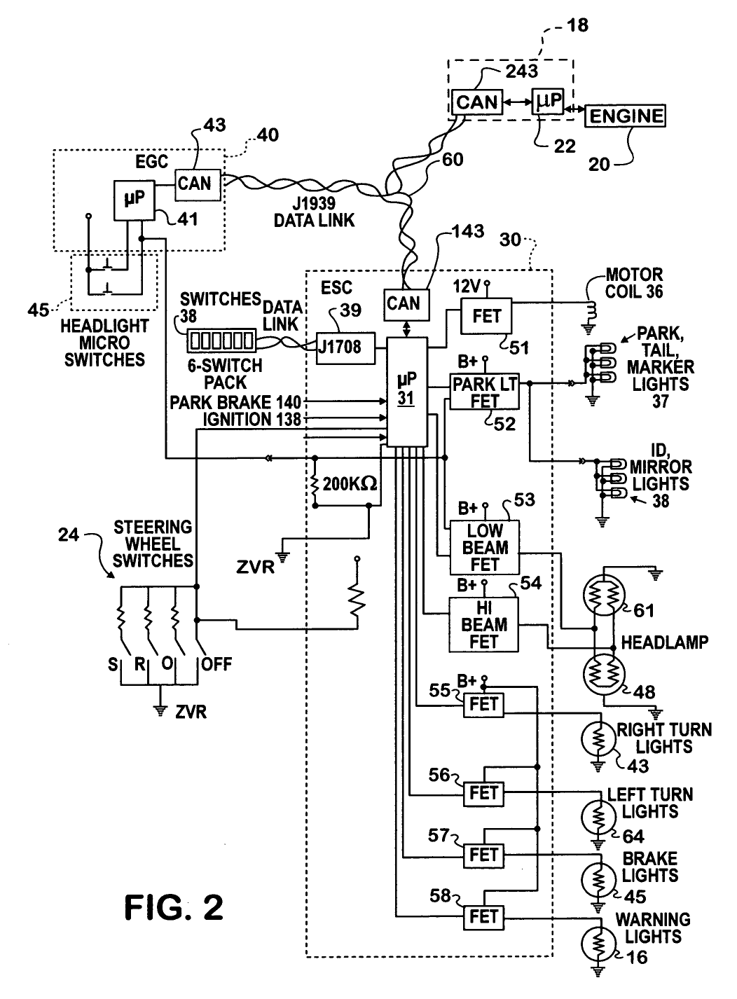

Referring now to FIG. 2, a mixed circuit block diagram schematic illustrates selected vehicle systems, including vehicle exterior lights. The illustrated vehicle controllers include an engine controller 18, an electrical gauge controller 40 and an electrical system controller (ESC) 30. Engine controller 18, electrical gauge controller (EGC) 40 and ESC 30 exchange data over an SAE J1939 datalink 60, which is a controller area network (CAN) implemented by CAN interfaces 143, 43 and 243, associated with ESC 30, EGC 40 and the engine controller 18, respectively. The controllers implement control functions over selected vehicle systems. Engine controller 18 controls the operation of engine 20, determining the amount of fuel to inject for example, and monitoring and reporting operating variables. A microprocessor 22 is installed in the controller to implement its operational and communication requirements. Electrical gauge controller 40 is generally used to control display gauges and to monitor operator switches, including headlight microswitches 45. Electrical gauge controller 40 microprocessor 41 is connected to receive and interpret inputs for broadcast over datalink 60. ESC 30 has more general responsibilities, including controlling the operation of all vehicle exterior lamps, which control is implemented by suitable programming of microprocessor 31. The ignition input 138 is conventionally directly connected to the ESC 30.

DRL operation is implemented by electrical system controller 30 depending upon the status of various vehicle systems and switches. DRL operation here is taken to mean operation of the lowbeams of vehicle headlamps 61, 48, potentially at reduced output levels, by control of the switching state of lowbeam FET 53. Low Beam FET 53 is one of a plurality of power field effect power (FET) switching transistors 51, 52, 53, 54, 55, 56, 57 and 58, most of which are employed to turn vehicle exterior lights on and off. In particular FET 51 is connected to drive a warning arm positioning motor coil 36, park light FET 52 is connected to drive assorted marker, park and tail lights 37, 38, FET 55 is connected to drive the right turn signal lamps 43, FET 56 is connected to drive left turn signal lamps 64 and FET 57 is connected to drive the brake lamps 45 and FET 58 is connected to illuminate the pupil boarding warning lamps 16.

Microprocessor 31 is conventionally programmed as a microcontroller. The programming directs responses to various status indications and switch inputs, whether directly received, or decoded from messages broadcast over the controller area network, or received over other datalinks, such as a SAE J1708 serial datalink through datalink interface 39. Because of the availability of status inputs from various sources to microprocessor 31, DRL operation can be closely tied to operating conditions indicated by the inputs. The particular inputs of interest here are an engine running message generated by the engine controller 20, the status of a warning light switch determined by the ESC 30 from switches 38 or steering wheel switches 24, ignition status from ignition 138, and park brake 140 status. The status of park brake 140 and ignition 138 are applied directly to the ESC 30.

As an initial matter, DRL operation is not called for if headlamps are turned on in response to closure of headlight microswitches 45. Otherwise, DRL operation begins with meeting selected conditions. The conditions to be monitored are: (1) ignition (26 or 138) status; (2) warning light active status; (3) engine running status; and (4) park brake status.

The present invention, in a preferred embodiment, allows modifying DRL operation, such as to disable DRL operation of the headlamps when the vehicle is not in motion, unless the vehicle is used as a school bus and is embarking or disembarking pupils. During passenger loading and unloading a school bus operator will engage warning lights 16 and extend a signal arm. Accordingly, microprocessor 31 may be programmed to discontinue DRL operation in response to setting the parking brake unless warning lights have been turned on. Warning lights may be turned on using a switch in a switch pack 38 connected to the microprocessor by an SAE J1708 datalink (or equivalent), or, by use of steering wheel switches 24 where such switches have been modified to implement warning functions.

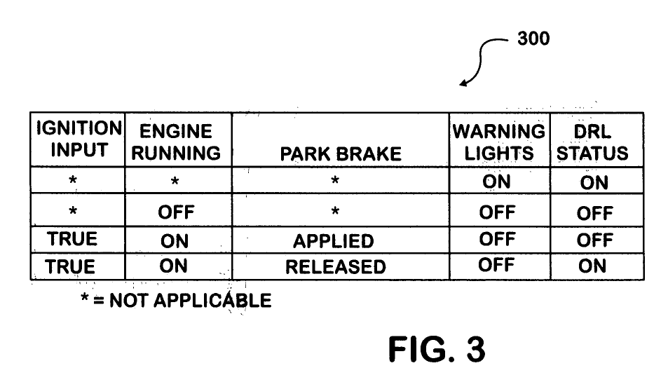

Referring now to FIG. 3, a truth table 300 illustrates operation of the programming of electrical system controller 30. The table is applied assuming that the headlamps 61, 48 have not been turned on. If the warning lights are on, DRL status is high, regardless of the status of the ignition, engine running variable and park brake position. If the engine is off and the warning lights are off then DRL status is low regardless of the status of the ignition or park brake. If the engine is running, ignition input is true and the park brake applied then the DRL status is low. Finally, if the park brake is released but the engine remains running, the ignition input remains true and the warning lights or off then DRL status is high.

While the invention is shown in only one of its forms, it is not thus limited but is susceptible to various changes and modifications without departing from the spirit and scope of the invention.

1. A vehicle lighting control system for implementing operating condition sensitive daytime running light operation of vehicle headlamps, the vehicle lighting control system comprising:
a plurality of exterior lamps installed on a vehicle including warning lights and the vehicle headlamps for automatic daytime running light operation;
an ignition switch;
a park brake position indication switch;
a headlamp control switch;
an engine controller for reporting engine operational status;
a warning light activation switch; and
a system controller coupled to monitor the status inputs from the ignition switch, the park brake position indication switch, the headlamp control switch and the warning light activation switch, and further coupled to the engine controller for receiving reported engine operational status, the system controller being programmed to illuminate the headlamps in daytime operational mode in response to the headlamp control switch being off and to a concurrent pre-selected state being met for at least one of: (1) the ignition switch status, (2) the park brake position indication switch status, (3) the warning light activation switch status, and (4) the engine operational status.

2. A vehicle lighting control system as claimed in claim 1, wherein the headlamps are illuminated in daytime running light mode responsive to the following status indications:
(1) the status input for the warning lights is high; or
(2) the status input for the warning lights is low, and remaining status inputs indicate that the engine is running, the ignition input is true and the park brake is released.

3. A vehicle lighting control system as claimed in claim 2, wherein the headlamps are not illuminated for daytime running light mode for the following status inputs:
the status inputs indicate that the engine is running and the warning lights are off.

4. A vehicle lighting control system as claimed in claim 2, wherein the headlamps are not illuminated for daytime running light mode under the following status indications:
the status indications are that the ignition input is true, the engine is running, the park brake is set and the warning lights are off.

5. A vehicle lighting control system as claimed in claim 3, wherein the headlamps are not illuminated for daytime running light mode under the following status indications:
the status indications are that the ignition input is true, the engine is running, the park brake is set and the warning lights are off.

6. A motor vehicle comprising;
exterior lighting including warning lights and headlamps;
a lighting control system for the warning lights and headlamps:
an electrical system controller including switching control for the exterior lighting;
an ignition switch coupled to the electrical system controller;
a park brake position indication switch coupled to the electrical system controller;
an engine;
an engine controller for controlling the engine and for reporting engine operational status to the electrical system controller; and
a warning light activation switch coupled to the electrical system controller;
a headlamp control switch coupled to the electrical system controller;
the system controller being coupled to receive status inputs from the ignition switch, the park brake position indication switch, the engine controller, the headlamp control switch and the warning light activation switch and further coupled to the headlamps for controlling the illumination of the headlamps in daytime running light mode in response to the status inputs including a status input of OFF from the headlamp control switch.

7. A motor vehicle as claimed in claim 6, wherein the headlamps are illuminated for daylight running light mode operation for the following status inputs:
(1) the warning light activation switch on is high; or
(2) the warning light activation switch is low, but the status inputs are that the engine is running, the ignition input is true and the park brake is released.

8. A motor vehicle as claimed in claim 7, wherein the headlamps are not illuminated for daylight running mode operation under the following status indications:
the status inputs are that the engine is running and the warning lights are off.

9. A motor vehicle as claimed in claim 7, wherein the headlamps are not illuminated for daylight running mode operation under the following status indications:
the status inputs are that the ignition input is true, the engine is running, the park brake is set and the warning lights are off.

10. A motor vehicle as claimed in claim 8, wherein the are not illuminated for daylight running mode operation under the following status indications:
the status indications are that the ignition input is true, the engine is running, the park brake is set and the warning lights are off.
